(19) United States
(12) Patent Application Publication
(10) Pub. No.: US 2024/0283066 A1
(43) Pub. Date: Aug. 22, 2024

(54) METHOD OF MANUFACTURING ELECTRICITY STORAGE DEVICE AND ELECTRICITY STORAGE DEVICE

(71) Applicant: Prime Planet Energy & Solutions, Inc., Tokyo (JP)

(72) Inventors: Yozo UCHIDA, Toyota-shi (JP); Yusuke ITOH, Kobe-shi (JP)

(21) Appl. No.: 18/432,056

(22) Filed: Feb. 5, 2024

(30) Foreign Application Priority Data
Feb. 16, 2023 (JP) 2023-022581

(51) Int. Cl. H01M 50/184; H01M 10/0525; H01M 10/0587; H01M 50/103; H01M 50/186; H01M 50/609

(52) U.S. Cl. CPC H01M 50/184; H01M 10/0525; H01M 10/0587; H01M 50/103; H01M 50/186; H01M 50/609

(57) ABSTRACT

Provided is a technique for improving impregnation efficiency of an electrolyte solution into a wound electrode body. A method for manufacturing an electricity storage device is disclosed herein. The electricity storage device includes an electrode body, a case, and an electrolyte solution. The case includes a body having a wide rectangular first wall and an opening opposed to the first wall, and a sealing plate that seals the opening and is opposed to the first wall. This method includes an accommodating step, an injecting step, and a sealing step. In the accommodating step, the electrode body is accommodated in the body to make the wide surfaces opposed to the first wall. In the injecting step, the electrolyte solution is injected into the body after the accommodating step. In the sealing step, the opening of the body is sealed with the sealing plate after the injecting step.

### CROSS REFERENCE TO RELATED APPLICATIONS

The present application claims the priority based on Japanese Patent Application No. 2023-022581 filed on Feb. 16, 2023, the entire contents of which are incorporated in the present application by reference.

### BACKGROUND OF THE DISCLOSURE

### 1. Technical Field

The present disclosure relates to a method of manufacturing an electricity storage device and an electricity storage device.

### 2. Background

In a lithium-ion battery disclosed in Japanese Patent Application Publication No. 2011-216239, a spacer at least a part of which is in close contact with an electrode element is disposed at each corner between a rectangular battery jar and a spiral electrode element. On the back side of each spacer, a space is provided as an escape route for air bubbles. This document states that, when the lithium-ion battery receives an impact from the outside of the rectangular battery jar, the impact concentrates on the top of a rounded portion of a short side surface of the electrode element but is dispersed by the spacer due to the above-described configuration, so that transmission of the impact to the electrode element is reduced, thus improving the impact resistance of the lithium-ion battery. When injection is performed for the rectangular battery jar, air bubbles escape not only from the top surface of the electrode element but also from the space provided on the back of the spacer. The document states that, as a result of the escape, permeability of an electrolyte solution in the electrode element is improved, and the injection time can be shortened.

A non-aqueous electrolyte secondary battery disclosed in Japanese Patent Application Publication No. H10-334879 includes an electrode stack and a case accommodating the electrode stack, and a pressing member is attached to apply pressure in an electrode stacking direction of the electrode stack. In this non-aqueous electrolyte secondary battery, a thin leaf spring processed into a shape producing elasticity in a direction perpendicular to a plate surface is used as the pressing member. This thin leaf spring is disposed in a gap between the inner surface of the case and the electrode stack. This document states that pressure can be applied to the electrode stack by a simple configuration in which the thin leaf spring is processed into a predetermined shape and disposed in the gap between the inner surface of the case and the electrode stack. It is also stated that such a configuration can prolong the life of the charge/discharge cycle of the non-aqueous electrolyte secondary battery.

In a flat rectangular battery disclosed in Japanese Patent Application Publication No. 2004-103368, a main body case is formed in the shape of a half-shell body in which a flange is provided around the opening of a concave portion by processing a metal plate. Electrode plate group is accommodated in the concave portion. A lid plate made of metal is disposed with its peripheral portion overlapping the flange and is joined to the flange by welding. In this battery, a dent is formed in the main body case and/or the lid plate in a direction in which the thickness of the battery is reduced. This publication states that when a force acts on the case in a swelling direction due to expansion of the electrode plate group accommodated in the case or an increase in internal pressure, the dent in the lid plate formed to have a lower deformation strength than the main body case swells outward, so that the thickness of the entire case is not affected, and the swelling does not affect a device in which the flat rectangular battery is loaded. For this reason, it is stated that such a configuration can contribute to the achievement of a thinner device.

### SUMMARY

The present inventors intend to increase the impregnation efficiency of the electrolytic solution into the wound electrode body.

A method of manufacturing an electricity storage device disclosed herein is a manufacturing method of an electricity storage device that includes: an electrode body including a positive electrode having a long sheet shape and a negative electrode having a long sheet shape, the positive and negative electrodes being wound in a sheet longitudinal direction with a separator interposed therebetween, the electrode body having a pair of opposed wide surfaces; a case having a cuboidal shape and configured to accommodate the electrode body, the case including a body having a first wall having a wide rectangular shape and an opening opposed to the first wall, and a sealing plate having a wide rectangular shape, opposed to the first wall and configured to seal the opening; and an electrolyte solution. This method includes the steps of: accommodating the electrode body in the body to make the wide surfaces and the first wall opposed to each other; injecting the electrolyte solution into the body after the accommodating step; and sealing the opening of the body with the sealing plate after the injecting step. According to the manufacturing method thus configured, impregnation efficiency of the electrolyte solution into the electrode body (the wound electrode body) can be increased.

In a preferable embodiment of the manufacturing method disclosed herein, the injecting step is performed under negative pressure. According to this configuration, the impregnation efficiency of the electrolyte solution into the electrode body can be further increased.

In another preferable embodiment of the manufacturing method disclosed herein, the electrolyte solution is injected into the body through the opening in the injecting step. According to this configuration, in addition to the advantageous effect described above, injection can be performed more easily.

In another preferable embodiment of the manufacturing method disclosed herein, in the sealing step, the opening of the body is sealed while the wide surface of the electrode body is pressed with the sealing plate. According to this configuration, a distance between electrodes in the electrode body into which the electrolyte solution has been sufficiently impregnated can be made smaller.

In another preferable embodiment of the manufacturing method disclosed herein, a sealing plate provided with a convex portion is used as the sealing plate in the sealing step. According to this configuration, the distance between electrodes can be kept small.

In another preferable embodiment of the manufacturing method disclosed herein, a pressing force of at least 6 kN is applied to the wide surface of the electrode body in the sealing step. According to this configuration, the distance between electrodes can be maintained in a preferable state.

According to a technique disclosed herein, an electricity storage device is provided which includes: an electrode body including a positive electrode having a long sheet shape and a negative electrode having a long sheet shape, the positive and negative electrodes being wound in a sheet longitudinal direction with a separator interposed therebetween, the electrode body having a pair of opposed wide surfaces; a case having a cuboidal shape and configured to accommodate the electrode body, the case including a body having a first wall having a wide rectangular shape and an opening opposed to the first wall, and a sealing plate having a wide rectangular shape, opposed to the first wall and configured to seal the opening; and an electrolyte solution. In this electricity storage device, no injection hole for injecting the electrolyte solution into the case is provided. In the electricity storage device having this configuration, the electrolyte solution is injected through the opening of the body because the injection hole is not provided. Accordingly, impregnation efficiency of the electrolyte solution into the electrode body is increased.

In a preferable embodiment of the electricity storage device disclosed herein, the sealing plate is provided with a convex portion protruding toward the wide surface of the electrode body. According to this configuration, a preferable distance between electrodes can be maintained in the electrode body.

It is preferable that a rib portion protruding toward the wide surface is further provided in the convex portion. According to this configuration, the advantageous effects described above can be enhanced.

### BRIEF DESCRIPTION OF THE DRAWINGS

FIG. 1 is a perspective view of an electricity storage device 1.

FIG. 2 is a cross-sectional view along line II-II in FIG. 1.

FIG. 3 is an exploded perspective view of a case 10.

FIG. 4 is a schematic diagram of an electrode body 20.

### DESCRIPTION OF THE EMBODIMENTS

An embodiment of a technique disclosed herein is described below. The embodiment described herein is not particularly intended to limit the technique disclosed herein. The technique disclosed herein is not limited to the embodiment described herein unless otherwise specified. The respective drawings have been schematically rendered and therefore may not necessarily reflect actual elements. Members and portions having the same action are labeled with the same reference signs as appropriate, and redundant description will be omitted. The phrase “A to B” indicating a range encompasses the meaning “A or more and B or less” and also encompasses the meaning “larger than A and smaller than B”, unless otherwise specified.

In the present specification, an “electricity storage device” means a device in which charge and discharge are caused by movement of charge carriers between a pair of electrodes (a positive electrode and a negative electrode) through an electrolyte. Such an electricity storage device encompasses a secondary battery such as a lithium-ion battery, a nickel-metal hydride battery, and a nickel-cadmium battery, and a capacitor such as a lithium-ion capacitor and an electric double-layer capacitor. In the following description, an embodiment directed to a lithium-ion battery as an example of the electricity storage device is described.

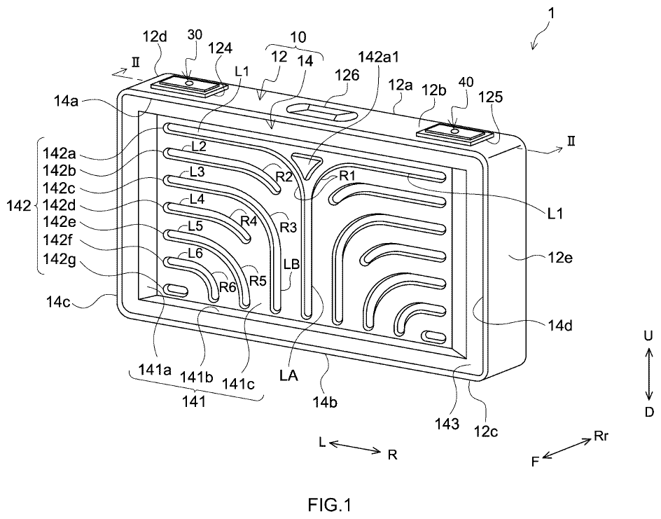

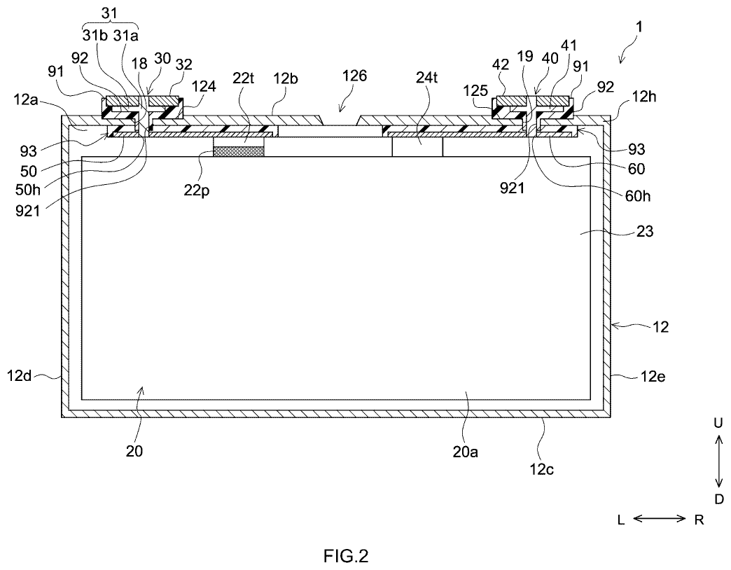

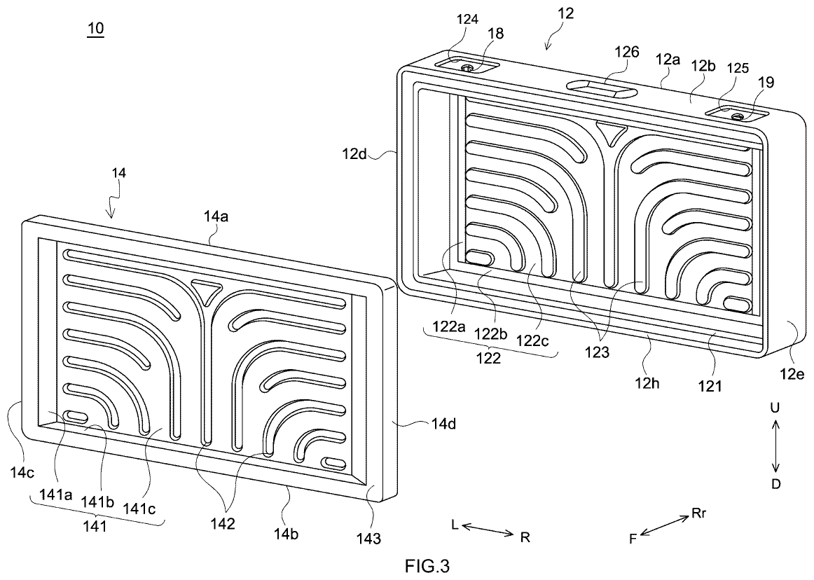

FIG. 1 is a perspective view of the electricity storage device 1. FIG. 2 is a cross-sectional view along line II-II in FIG. 1. FIG. 2 illustrates a cross-section along a first wall 12a of the case 10. FIG. 3 is an exploded perspective view of the case 10. FIG. 3 illustrates a body 12 and a sealing plate 14 detached from an opening 12h of the body 12 separately.

### <Electricity Storage Device 1>

According to the technique disclosed herein, the electricity storage device 1 is provided. The electricity storage device 1 includes the case 10, the electrode body 20, a positive electrode terminal 30, a negative electrode terminal 40, a positive electrode current collector 50, a negative electrode current collector 60, an electrolyte solution (not illustrated), and various insulating members, as illustrated in FIGS. 1 and 2.

### —Case 10—

The case 10 is, for example, a member in the shape of a cuboid (a hexahedron) that accommodates the electrode body 20. As illustrated in FIG. 1, the case 10 includes the body 12 and the sealing plate 14. The body 12 is, for example, the main body of the case 10, which accommodates the electrode body 20 therein. The body 12 has the opening 12h, the first wall 12a, a pair of opposed second walls 12b and 12c, and a pair of opposed third walls 12d and 12e, as illustrated in FIGS. 1 to 3. In the present embodiment, the first wall 12a is wide and rectangular and is opposed to the opening 12h. The second walls 12b and 12c extend from a pair of opposed long sides of the first wall 12a, respectively. As illustrated in FIGS. 1 and 2, the lower second wall 12c configures the bottom surface of the electricity storage device 1. The upper second wall 12b is the top surface opposed to the bottom surface and serves as an attaching surface for electrode terminals. The third walls 12d and 12e extend from a pair of opposed short sides of the first wall 12a, respectively. In this specification, a “rectangular shape” encompasses a shape in which a long side and a short side that are straight are joined to each other via a curve, a shape in which at least one of the long side and the short side is not straight but curved, uneven, or bent to include a plurality of straight lines or curves, and the like.

The opening 12h is, for example, a portion to which the sealing plate 14 is attached. Here, the opening 12h is formed by being surrounded by the upper edges of the second walls 12b and 12c and the upper edges of the third walls 12d and 12e and is wide and rectangular. As illustrated in FIG. 3, a step 121 is provided in the opening 12h, which is dented along the inner edge thereof. Here, the sealing plate 14 is fitted into the step 121. By joining (e.g., welding) the sealing plate 14 to the step 121, the body 12 and the sealing plate 14 are integrated together, so that the case 10 is sealed airtightly.

In the form illustrated in FIG. 3, the first wall 12a is provided with a convex portion 122 and a rib portion 123. The convex portion 122 is a portion protruding from the first wall 12a to the inside of the case 10, for example. Here, the convex portion 122 has a pair of opposed short side walls 122a, a pair of opposed long side walls 122b, and a flat surface 122c. As illustrated in FIG. 3, the short side walls 122a stand from the first wall 12a toward the inside of the case 10 along a pair of opposed short sides of the first wall 12a. The long side walls 122b stand from the first wall 12a toward the inside of the case 10 along a pair of opposed long sides of the first wall 12a. The flat surface 122c here is surrounded by the ends of the opposed short side walls 122a and the ends of the opposed long side walls 122b. The flat surface 122c is opposed to a wide surface 20a of the electrode body 20, for example (see FIGS. 1 to 3). From the viewpoint of efficiently applying a pressing force to the electrode body 20, assuming that the area of the wide surface 20a is 1, the area of the flat surface 122c is, for example, 0.7 or more, preferably 0.8 or more, more preferably 0.9 or more and, although not particularly limited, may be 1.3 or less, 1.2 or less, or 1.1 or less.

The rib portion 123 is a portion protruding from the flat surface 122c toward the inside of the case 10 (toward the wide surface 20a of the electrode body 20), for example. In the form illustrated in FIG. 3, the rib portion 123 may be provided in streaks arranged in a predetermined pattern, for example. The shape of each rib configuring the rib portion 123 may be the same as or different from the shape of each rib in a rib portion 142 of the sealing plate 14. The tip end of the rib portion 123 here is in contact with the wide surface 20a of the electrode body 20. By provision of the convex portion 122 and the rib portion 123, a pressing force can be applied to the wide surface 20a of the electrode body 20, for example, so that a preferable distance between electrodes can be maintained in the electrode body 20. The convex portion 122 and the rib portion 123 are not essential, and may be omitted in another embodiment.

As illustrated in FIGS. 1 to 3, the second wall 12b is provided with a discharge valve 126, a first terminal attaching portion 124, and a second terminal attaching portion 125. The discharge valve 126 is, for example, a thin portion. Here, the discharge valve 126 is configured to be broken to allow gas in the case 10 to be discharged to outside therethrough when the pressure in the case 10 reaches a predetermined value or more. The first terminal attaching portion 124 is a portion to which the positive electrode terminal 30 is attached, for example. In the form illustrated in FIGS. 1 to 3, the first terminal attaching portion 124 is a step that is dented from the second wall 12b. In the bottom of the first terminal attaching portion 124 is provided a through hole 18 through which the positive electrode terminal 30 is inserted and penetrates. The second terminal attaching portion 125 is a portion to which the negative electrode terminal 40 is attached, for example. In the form illustrated in FIGS. 1 to 3, the second terminal attaching portion 125 is a step that is dented from the second wall 12b. In the bottom of the second terminal attaching portion 125 is provided a through hole 19 through which the negative electrode terminal 40 is inserted and penetrates.

The sealing plate 14 is, for example, a flat plate member that seals the opening 12h. Therefore, it is desirable that the sealing plate 14 has a shape according to the shape of the opening 12h. In the present embodiment, the sealing plate 14 is wide and rectangular. Here, when the sealing plate 14 is attached to the opening 12h, the sealing plate 14 is opposed to the first wall 12a. As illustrated in FIG. 3, the sealing plate 14 has a pair of opposed long side portions 14a and 14b and a pair of opposed short side portions 14c and 14d. Here, the long side portion 14a is placed on the bottom of the step 121 in the second wall 12b. The long side portion 14b is placed on the bottom of the step 121 in the second wall 12c. The short side portion 14c is placed on the bottom of the step 121 in the third wall 12d. The short side portion 14d is placed on the bottom of the step 121 in the third wall 12e.

As illustrated in FIGS. 1 and 3, the sealing plate 14 has a convex portion 141, the rib portion 142, and an edge portion 143. The convex portion 141 has, for example, a pair of opposed short side walls 141a, a pair of opposed long side walls 141b, and a flat surface 141c. As illustrated in FIG. 3, the short side walls 141a stand from the edge portion 143 toward the inside of the case 10 along the opposed short side portions 14c and 14d of the sealing plate 14. The long side walls 141b stand from the edge portion 143 toward the inside of the case 10 along the opposed long side portions 14a and 14b of the sealing plate 14. The flat surface 141c here is surrounded by the ends of the opposed short side walls 141a and the ends of the opposed long side walls 141b. The flat surface 141c is opposed to the wide surface 20a of the electrode body 20, for example (see FIGS. 1 to 3). From the viewpoint of efficiently applying a pressing force to the electrode body 20, assuming that the area of the wide surface 20a is 1, the area of the flat surface 141c is, for example, 0.7 to 0.9. The height of the convex portion 141 is not particularly limited and can be set appropriately.

The rib portion 142 is, for example, a portion protruding from the flat surface 141c toward the inside of the case 10. In the form illustrated in FIGS. 1 and 3, the rib portion 142 is formed on the flat surface 141c. The rib portion 142 protrudes from the flat surface 141c toward the wide surface 20a of the electrode body 20 (toward the inside of the case 10). It is desirable that the rib portion 142 is provided in streaks arranged in a predetermined pattern, for example. In the form illustrated in FIG. 1, the rib portion 142 has a first rib 142a, a pair of second ribs 142b, a pair of third ribs 142c, a pair of fourth ribs 142d, a pair of fifth ribs 142e, a pair of sixth ribs 142f, a pair of seventh ribs 142g that are different from one another in shape.

In the present embodiment, the first rib 142a and the second ribs 142b to the sixth ribs 142f respectively have straight portions L1 to L6 arranged along the opposed long side portions 14a and 14b of the sealing plate 14. The first rib 142a and the second ribs 142b to the sixth ribs 142f have curved portions R1 to R6 that extend from ends of the straight portions L1 to L6 toward the long side portion 14b opposite to the long side portion 14a (that is a long side portion on the second wall 12b side, i.e., the terminal attaching surface side of the body 12), the ends of the straight portions L1 to L6 being ends closer to the center of the sealing plate 14. Here, the first rib 142a is approximately T-shaped and has a straight portion LA in addition to the straight portion L1 and the curved portion R1. The straight portion LA extends from the curved portion R1 toward the long side portion 14b. In a coupling portion that couples the straight portion L1, the curved portion R1, and the straight portion LA, a concave portion 142a1 is provided which is substantially triangular in plan view. The concave portion 142a1 here is concave in a direction from the inside of the case 10 toward the outside. By provision of the concave portion 142a1, a pressing force is not applied to this portion. Thus, lowering of the performance of the electricity storage device 1 can be suppressed. The third ribs 142c are approximately L-shaped and have straight portions LB in addition the straight portions L3 and the curved portion R3. The straight portion LB extends from the curved portion R3 toward the long side portion 14b. The seventh ribs 142g here are approximately rectangular in plan view. The seventh ribs 142g are arranged with the long side direction thereof extending along the long side portion 14b. The seventh ribs 142g are each provided to be surrounded by the corresponding sixth rib 142f, one short side portion 14c or the other short side portion 14d, and the long side portion 14b in FIG. 1.

In the form illustrated in FIG. 1, the terminating end (an end opposite to the straight portion L2) of the curved portion R2 of the second rib 142b is sandwiched between the curved portion R1 of the first rib 142a and the curved portion R3 of the third rib 142c. The terminating end (an end opposite to the straight portion L4) of the curved portion R4 of the fourth rib 142d is sandwiched between the curved portion R3 of the third rib 142c and the curved portion R5 of the fifth rib 142e. The terminating end (an end opposite to the curved portion R1) of the straight portion LA of the first rib 142a, the terminating ends (ends opposite to the curved portions R3) of the straight portions LB of the third ribs 142c, the terminating ends (ends opposite to the straight portions L5) of the curved portions R5 of the fifth ribs 142e, the terminating ends (ends opposite to the straight portions L6) of the curved portions R6 of the sixth ribs 142f, and the seventh ribs 142g are arranged along the long side portion 14b.

Due to the shape of the rib portion 142 described above, a pressing force can be efficiently applied to the wide surface 20a, so that a preferable distance between electrodes can be achieved. In addition, the electrolyte solution can be prevented from being pushed out by expansion and contraction of the electrode body 20 from the inside of the electrode body 20 to the outside, by a linear pressure. Therefore, depletion of the electrolyte solution in the electrode body 20 during charge and discharge of the electricity storage device 1 can be suppressed by the rib portion 142.

Here, the protruding end of each rib configuring the rib portion 142 is in contact with the wide surface 20a of the electrode body 20. While the opening 12h is sealed with the sealing plate 14, a pressing force is applied to the wide surface 20a of the electrode body 20 by the rib portion 142. Assuming that the area of the flat surface 141c is 1, the area of contact between the rib portion 142 and the wide surface 20a (the total area of the protruding ends of the respective ribs in the rib portion 142) is, for example, 0.2 to 0.8, preferably 0.3 or more, more preferably 0.4 or more and may be 0.7 or less, preferably 0.6 or less. Due to this, a preferable distance between electrodes can be maintained. The height of each rib is not particularly limited and can be set appropriately.

The edge portion 143 here is a portion provided in the periphery of the sealing plate 14. As illustrated in FIGS. 1 and 3, the edge portion 143 is provided along the long side portions 14a and 14b and the short side portions 14c and 14d. The edge portion 143 is provided around the convex portion 141. The edge portion 143 here is not provided with irregularities, a through hole, or the like.

In the present embodiment, the case 10 is not provided with an injection hole for injecting an electrolyte solution into the case 10. As described later in the description of a manufacturing method, injection of the electrolyte solution into the case 10 is performed through the opening 12h.

### —Electrode Body 20—

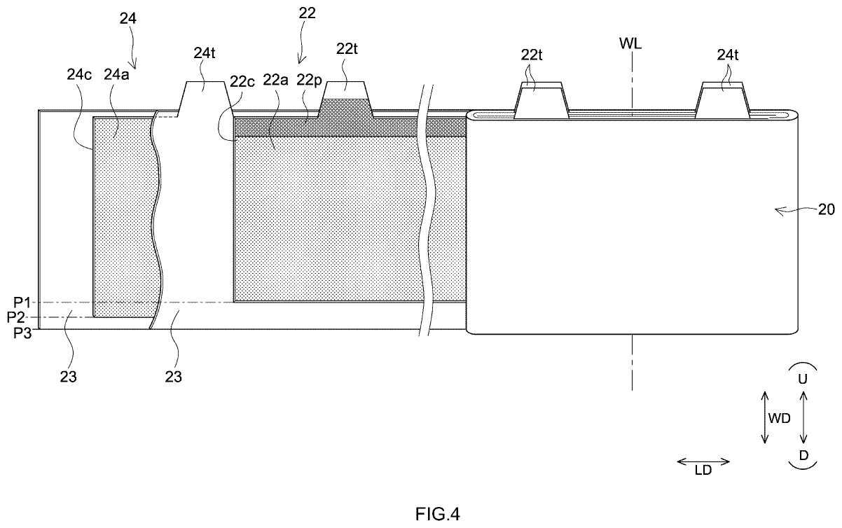

The electrode body 20 is a power generation element of the electricity storage device 1 having a positive electrode and a negative electrode, for example. FIG. 4 is a schematic diagram of the electrode body 20. As illustrated in FIG. 4, the electrode body 20 is a wound electrode body that includes a positive electrode 22 having a long sheet shape and a negative electrode 24 having a long sheet shape, the positive and negative electrodes being wound in a sheet longitudinal direction LD with a separator 23 interposed therebetween. The electrode body 20 can be manufactured by, for example, winding the positive electrode 22, the negative electrode 24, and the separator 23 to form a cylindrical body and performing press-molding for the cylindrical body. The electrode body 20 thus has a flattened shape and has a pair of wide surfaces 20a (see FIG. 2).

As illustrated in FIGS. 2 and 4, the electrode body 20 is accommodated in the body 12 in such a manner that a winding axis direction WD and the vertical direction of the electricity storage device 1 are approximately parallel to each other. In the present embodiment, a winding axis WL of the electrode body 20 is approximately parallel to the first wall 12a, the third walls 12d and 12e, and the sealing plate 14 and is approximately perpendicular to the second walls 12b and 12c. The wide surfaces 20a of the electrode body 20 are opposed to the first wall 12a and the sealing plate 14. One end surface of the electrode body 20 is opposed to the second wall 12b, and the other end surface is opposed to the second wall 12c. The end surfaces of the electrode body 20 here are laminated surfaces of the positive electrode 22, the negative electrode 24, and the separator 23 and are open.

As illustrated in FIG. 4, the positive electrode 22 has a positive electrode current collecting foil 22c (e.g., an aluminum foil) that is long and band-shaped and a positive electrode active material layer 22a fixed to at least one surface of the positive electrode current collecting foil 22c. A protection layer 22p may be provided on one side edge portion in the winding axis direction WD of the positive electrode 22, if necessary, although not particularly limited. As the constituent material for the positive electrode active material layer 22a and the constituent material for the protection layer 22p, materials used in this type of electricity storage device (a lithium-ion battery in the present embodiment) may be used without any restriction.

A plurality of positive electrode tabs 22t are provided at one end (an upper end in FIG. 4) of the positive electrode current collecting foil 22c in the winding axis direction WD. The positive electrode tabs 22t protrude toward the one end (the upper end in FIG. 4) in the winding axis direction WD. The positive electrode tabs 22t are provided at intervals (intermittently) along the longitudinal direction LD of the positive electrode 22. The positive electrode tabs 22t are portions of the positive electrode current collecting foil 22c in which the positive electrode active material layer 22a of the positive electrode current collecting foil 22c is not formed (an active-material-layer unformed portion). In the embodiment illustrated in FIG. 4, the protection layer 22p is provided on the base side of the positive electrode tab 22t. In the present embodiment, the positive electrode tabs 22t protrude in the winding axis direction WD with respect to the separator 23. The positive electrode tabs 22t are stacked at the one end (the upper end in FIG. 4) in the winding axis direction WD to configure a positive electrode tab group. Therefore, the positive electrode tabs 22t do not have to be the same as one another in height (length in the winding axis direction WD) and width (length in the longitudinal direction LD). As illustrated in FIG. 2, the positive electrode current collector 50 is joined to the stacked positive electrode tabs 22t (the positive electrode tab group).

As illustrated in FIG. 4, the negative electrode 24 has a negative electrode current collecting foil 24c (e.g., a copper foil) that is long and band-shaped and a negative electrode active material layer 24a fixed to at least one surface of the negative electrode current collecting foil 24c. As the constituent material for the negative electrode active material layer 24a, a material used in this type of electricity storage device (a lithium-ion battery in the present embodiment) may be used without any restriction.

A plurality of negative electrode tabs 24t are provided at one end (the upper end in FIG. 4) of the negative electrode current collecting foil 24c in the winding axis direction WD. The negative electrode tabs 24t protrude toward the one end (the upper end in FIG. 4) in the winding axis direction WD. The negative electrode tabs 24t are provided at intervals (intermittently) along the longitudinal direction LD of the negative electrode 24. The negative electrode tabs 24t are portions of the negative electrode current collecting foil 24c in which the negative electrode active material layer 24a of the negative electrode current collecting foil 24c is not formed (an active-material-layer unformed portion). In the present embodiment, the negative electrode tabs 24t protrude in the winding axis direction WD with respect to the separator 23. For example, the negative electrode tabs 24t are stacked at the one end (the upper end in FIG. 4) in the winding axis direction WD to configure a negative electrode tab group. Therefore, the negative electrode tabs 24t does not have to be the same as one another in height (length in the winding axis direction WD) and width (length in the longitudinal direction LD). As illustrated in FIG. 2, the negative electrode current collector 60 is joined to the stacked negative electrode tabs 24t (the negative electrode tab group).

The separator 23 is a member that insulates the positive electrode active material layer 22a of the positive electrode 22 and the negative electrode active material layer 24a of the negative electrode 24 from each other. In the present embodiment, the separator 23 configures an outer surface of the electrode body 20. As the separator 23, a resin porous sheet made of a polyolefin resin such as polyethylene (PE) and polypropylene (PP) is used.

As illustrated in FIG. 4, in the electrode body 20, a lower end P3 of the separator 23 is located at the bottom, a lower end P2 of the negative electrode 24 is located above it, and a lower end P1 of the positive electrode 22 is located at the top. The width (the length in the winding axis direction WD in FIG. 4 without the positive electrode tabs 22t and the negative electrode tabs 24t) of each sheet is set in such a manner that the largest is the separator 23, and followed by the negative electrode 24 and the positive electrode 22 in this order.

### —Positive Electrode Terminal 30—

The positive electrode terminal 30 is, for example, a member electrically connected to the positive electrode 22 of the electrode body 20. As illustrated in FIG. 2, the positive electrode terminal 30 is inserted into the through hole 18 to penetrate therethrough and exposed to the outside of the body 12. Here, the positive electrode terminal 30 includes a first conductive member 31 and a second conductive member 32. In the present embodiment, the first conductive member 31 has a shaft 31a and a base portion 31b. The shaft 31a is, for example, cylindrical and is a portion that is inserted into the through hole 18 and a through hole of the second conductive member 32 to penetrate therethrough. The base portion 31b has a shape of a flat plate, for example, and is a portion arranged along the outer surface (here, the second wall 12b) of the body 12. The second conductive member 32 has a shape of a flat plate, for example, and is a portion connected to a busbar when a battery pack is constructed. In the present embodiment, the second conductive member 32 is rectangular. The first conductive member 31 and the second conductive member 32 are connected to each other outside the case 10. The first conductive member 31 is made of, for example, aluminum or aluminum alloy. The second conductive member 32 is made of, for example, aluminum, aluminum alloy, copper, or copper alloy.

The negative electrode terminal 40 is, for example, a member electrically connected to the negative electrode 24 of the electrode body 20. As illustrated in FIG. 2, the negative electrode terminal 40 is inserted into the through hole 19 to penetrate therethrough and exposed to the outside of the body 12. Here, the negative electrode terminal 40 includes a first conductive member 41 and a second conductive member 42. The first conductive member 41 is made of, for example, copper or copper alloy. The negative electrode terminal 40 may have a similar configuration to the positive electrode terminal 30, for example. Therefore, the description of the construction of the negative electrode terminal 40 is omitted here.

### —Positive Electrode Current Collector 50—

The positive electrode current collector 50 is, for example, a member that electrically connects the positive electrode tabs 22t and the positive electrode terminal 30 to each other. The positive electrode current collector 50 is, for example, a plate-shaped conductive member. As illustrated in FIG. 2, the positive electrode current corrector 50 extends in the direction of the long side of the second wall 12b along the inner surface of the body 12 (here, the inner side of the second wall 12b). The positive electrode tabs 22t (here, the positive electrode tab group) are connected to one end (the right end in FIG. 2) of the positive electrode current collector 50. At the other end (the left end in FIG. 2) of the positive electrode current collector 50, a lower end of the shaft 31a of the positive electrode terminal 30 is inserted through a through hole 50h to penetrate therethrough and crimped. The positive electrode current collector 50 is made of, for example, aluminum or aluminum alloy.

### —Negative Electrode Current Collector 60—

The negative electrode current collector 60 is, for example, a member that electrically connects the negative electrode tabs 24t and the negative electrode terminal 40 to each other. The negative electrode current collector 60 is, for example, a plate-shaped conductive member. As illustrated in FIG. 2, the negative electrode current corrector 60 extends in the direction of the long side of the second wall 12b along the inner surface of the body 12 (here, the inner side of the second wall 12b). The negative electrode tabs 24t (here, the negative electrode tab group) are connected to one end (the left end in FIG. 2) of the negative electrode current collector 60. At the other end (the right end in FIG. 2) of the negative electrode current collector 60, a lower end of the negative electrode terminal 40 is inserted through a through hole 60h to penetrate therethrough and crimped. The negative electrode current collector 60 is made of, for example, copper or copper alloy.

### —Electrolyte Solution—

An electrolyte solution contains, for example, an electrolyte salt and a non-aqueous solvent. Examples of the electrolyte salt include LiPF₆. The concentration of the electrolyte salt in the electrolyte solution is, for example, 0.7 mol/L to 1.3 mol/L. The non-aqueous solvent may be, for example, a carbonate. Examples of the carbonate include ethylene carbonate (EC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), and trifluorodimethyl carbonate (TFDMC). These carbonates can be used alone or in combination of two or more.

### —Insulating Member—

The electricity storage device 1 uses various insulating members. For example, as illustrated in FIG. 2, outside the case 10, external insulating members 91 are arranged between the second conductive member 32 of the positive electrode terminal 30 and the second wall 12b and between the second conductive member 42 of the negative electrode terminal 40 and the second wall 12b, respectively. Outside the case 10, gaskets 92 are arranged between the first conductive member 31 and the second wall 12b and between the first conductive member 41 and the second wall 12b, respectively. The gaskets 92 have tubular portions 921 respectively arranged on the inner circumference of the through hole 18 and the inner circumference of the through hole 19. Inside the case 10, internal insulating members 93 are arranged between the positive electrode current collector 50 and the second wall 12b and between the negative electrode current collector 60 and the second wall 12b, respectively.

The electricity storage device 1 is used for various applications and in particular, can be preferably used as a power source (a driving power source) for a motor mounted on a vehicle such as a passenger car and a truck. The kind of the vehicle is not particularly limited, and preferable examples thereof include a plug-in hybrid vehicle (PHEV), a hybrid vehicle (HEV), and a battery electric vehicle (BEV).

As described above, the electricity storage device 1 includes the electrode body 20, the case 10, and the electrolyte solution. The electrode body 20 includes the positive electrode 22 having the long sheet shape and the negative electrode 24 having the long sheet shape, the positive and negative electrodes being wound in the sheet longitudinal direction with the separator 23 interposed therebetween. The electrode body 20 has a pair of wide surfaces 20a opposed to each other. The case 10 is a case in the shape of a cuboid that accommodates the electrode body 20. The case 10 includes the body 12 having the first wall 12a that is wide and rectangular and the opening 12h opposed to the first wall 12a, and the wide, rectangular sealing plate 14 that is to seal the opening 12h and is opposed to the first wall 12a. The electricity storage device 1 is not provided with an injection hole for injecting the electrolyte solution into the case 10.

Since the electricity storage device 1 thus configured is not provided with an injection hole, the electrolyte solution is injected through the opening 12h of the body 12. Accordingly, the body 12 is sealed after injection of the electrolyte solution. This can increase impregnation efficiency of the electrolyte solution into the electrode body 20. In addition, since a process of providing the injection hole can be omitted, productivity of the electricity storage device 1 can be improved.

In the electricity storage device 1, the sealing plate 14 is provided with the convex portion 141 that protrudes toward the wide surface 20a of the electrode body 20. By using the sealing plate 14 provided with the convex portion 141, a pressing force can be applied to the wide surface 20a of the electrode body 20. Accordingly, a preferable distance between electrodes can be maintained.

In the convex portion 141, the rib portion 142 is further provided which protrudes toward the wide surface 20a. By using the sealing plate 14 provided with the rib portion 142 together with the convex portion 141, a pressing force can be applied to the wide surface 20a of the electrode body 20 more efficiently. Accordingly, the effect of maintaining the preferable distance between electrodes can be enhanced.

### <Method of Manufacturing Electricity Storage Device 1>

According to the technique disclosed herein, a method of manufacturing the electricity storage device 1 is provided. This manufacturing method includes, for example, an accommodating step, a joining step, an injecting step, and a sealing step.

### —Accommodating Step—

The accommodating step is a process of accommodating the electrode body 20 in the body 12, for example. Here, the electrode body 20 is accommodated in the body 12 in such a manner that the wide surface 20a and the first wall 12a are opposed to each other (see FIG. 2). It is preferable to attach the positive electrode terminal 30, the negative electrode terminal 40, the positive electrode current collector 50, the negative electrode current collector 60, and various insulating members to the second wall 12b of the body 12 prior to the accommodating step.

### —Joining Step—

The joining step is a process of joining an electrode tab and an electrode current collector to each other, for example. In the present embodiment, after the electrode body 20 is accommodated in the body 12 (after the accommodating step), the positive electrode tabs 22t are joined to the positive electrode current collector 50, and the negative electrode tabs 24t are joined to the negative electrode current collector 60. A method of joining the electrode tab and the electrode current collector to each other is, for example, laser welding. In the joining step, a first assembly is obtained in which the electrode body 20 and the body 12 are integrated together.

### —Injecting Step—

The injecting step is, for example, a process of injecting an electrolyte solution into the body 12 after the accommodating step (here, after the joining step performed after the accommodating step). In the present embodiment, the electrolyte solution is injected into the body 12 through the opening 12h. By injecting the electrolyte solution into the body 12 through the opening 12h, provision of an injection hole in the body 12 can be omitted. The injecting step can thus be performed more easily. For example, the injecting step may be performed under negative pressure. This can increase impregnation efficiency of the electrolyte solution into the electrode body 20. In this case, the first assembly obtained in the joining step may be placed under negative pressure (e.g., in a negative-pressure chamber), and thereafter the injecting step may be performed, for example.

### —Sealing Step—

The sealing step is, for example, a process of sealing the opening 12h of the body 12 with the sealing plate 14. In this step, the body 12 and the sealing plate 14 are welded (for example, by laser welding) to each other, for example. Thus, a second assembly is obtained in which both of them are integrated together and the case 10 is sealed. Here, the sealing step is performed after the injecting step. In the sealing step, it is preferable to seal the opening 12h of the body 12 while applying pressure to the wide surface 20a of the electrode body 20 with the sealing plate 14, for example. By applying pressure to the wide surface 20a of the electrode body 20 in the sealing step, a distance between electrodes can be made smaller in the electrode body impregnated with the electrolyte solution.

As described above, the sealing plate 14 is provided with the convex portion 141 and the rib portion 142. In the sealing step, the rib portion 142 may be brought into contact with the wide surface 20a of the electrode body 20 to apply pressure to the electrode body 20. By using the sealing plate 14 provided with the convex portion 141 and the rib portion 142 as a sealing plate for sealing the body 12, a pressing force can continue to be applied to the wide surface 20a of the electrode body 20, also after the body 12 is sealed. Accordingly, the distance between electrodes can be kept smaller.

In the sealing step, a pressing force of at least 6 kN may be applied to the wide surface 20a of the electrode body 20, although not particular limited. This provides a preferable distance between electrodes. The pressing force is desirably 10 kN or less, for example, and may be 8 kN or less. The pressing force is an average pressing force applied to the wide surface 20a. The average pressing force is, for example, a value obtained by dividing the total of the pressing force applied to the wide surface 20a by the area of the wide surface 20a at room temperature. To enable a desired pressing force to be applied to the wide surface 20a, the height of the convex portion 141 and the height of the rib portion 142, for example, may be adjusted appropriately.

Aging treatment is then performed for the second assembly obtained in the sealing step under a predetermined condition, so that the electricity storage device 1 that is ready for use can be obtained.

As described above, the method of manufacturing the electricity storage device 1 includes the accommodating step, the injecting step, and the sealing step. In the accommodating step, the electrode body 20 is accommodated in the body 12 in such a manner that the wide surface 20a and the first wall 12a are opposed to each other. In the injecting step, the electrolyte solution is injected into the body 12 after the accommodating step. In the sealing step, the opening 12h of the body 12 is sealed with the sealing plate 14 after the injecting step. Since the body 12 having a wide opening is used in the manufacturing method thus configured, the electrode body 20 can be easily accommodated in the body 12. Accordingly, the electrode body 20 can be accommodated in the body 12 without separately performing a process of reducing the thickness, for example. In this manufacturing method, injection of the electrolyte solution is performed after the electrode body 20 is accommodated in the body 12 before the opening 12h is sealed. Accordingly, in the injecting step, the distance between electrodes which enables easy impregnation with the electrolyte solution is ensured in the electrode body 20. The impregnation efficiency of the electrolyte solution into the electrode body 20 is thus increased.

In the embodiment described above, the sealing plate 14 is provided with the convex portion 141 and the rib portion 142. However, the sealing plate 14 is not limited thereto. For example, the shape of the rib portion 142 may not be the above-described shape. The rib portion 142 may be configured by dot-like ribs arranged in a predetermined pattern, for example. In place of the rib portion 142, a convex portion (e.g., a convex portion that is curved in a dome shape from the flat surface 141c toward the wide surface 20a) may be provided. Alternatively, an aspect may be employed in which only the convex portion 141 is provided in the sealing plate 14 but no rib portion 142 is provided. Alternatively, the rib portion 142, the above-described convex portion, or the like may be provided in the sealing plate 14 without the convex portion 141. Some configurations of the sealing plate 14 are exemplified herein, but the configuration thereof is not limited thereto. The configuration of the sealing plate 14 is not particularly limited, as long as the advantageous effects of the technique disclosed herein can be achieved.

Specific aspects of the technique disclosed herein are described as follows.
Item 1:
   A method of manufacturing an electricity storage device comprising:
   an electrode body including a positive electrode having a long sheet shape and a negative electrode having a long sheet shape, the positive and negative electrodes being wound in a sheet longitudinal direction with a separator interposed therebetween, the electrode body having a pair of opposed wide surfaces;
   a case having a cuboidal shape and configured to accommodate the electrode body, the case including a body having a first wall having a wide rectangular shape and an opening opposed to the first wall, and a sealing plate having a wide rectangular shape, opposed to the first wall and configured to seal the opening; and
   an electrolyte solution,
the method including the steps of:
   accommodating the electrode body in the body of the case to make the wide surfaces and the first wall opposed to each other;
   injecting the electrolyte solution into the body after the accommodating step; and
   sealing the opening of the body with the sealing plate after the injecting step.
Item 2:
   The manufacturing method recited in Item 1, wherein the injecting step is performed under negative pressure.
Item 3:
   The manufacturing method recited in Item 1 or 2, wherein the electrolyte solution is injected into the body through the opening in the injecting step.
Item 4:
   The manufacturing method recited in any one of Items 1 to 3, wherein in the sealing step, the opening of the body is sealed while the wide surface of the electrode body is pressed with the sealing plate.
Item 5:
   The manufacturing method recited in any one of Items 1 to 4, wherein a sealing plate provided with a convex portion is used as the sealing plate in the sealing step.
Item 6:
   The manufacturing method recited in any one of Items 1 to 5, wherein a pressing force of at least 6 kN is applied to the wide surface of the electrode body in the sealing step.
Item 7:
   An electricity storage device comprising:
   an electrode body including a positive electrode having a long sheet shape and a negative electrode having a long sheet shape, the positive and negative electrodes being wound in a sheet longitudinal direction with a separator interposed therebetween, the electrode body having a pair of opposed wide surfaces;
   a case having a cuboidal shape and configured to accommodate the electrode body, the case including a body having a wide, rectangular first wall and an opening opposed to the first wall, and a sealing plate having a wide rectangular shape, opposed to the first wall and configured to seal the opening; and
   an electrolyte solution,
wherein
   no injection hole for injecting the electrolyte solution into the case is provided.
Item 8:
   The electricity storage device recited in Item 7, wherein the sealing plate is provided with a convex portion protruding toward the wide surface of the electrode body.
Item 9:
   The electricity storage device recited in Item 8, wherein a rib portion protruding toward the wide surface is further provided in the convex portion.

The embodiment of the technique disclosed herein have been described above. It is not intended to limit the technique disclosed herein to the above-described embodiment. The technique disclosed herein can be implemented in various other embodiments. The techniques described in the claims include various modifications and changes of the embodiment illustrated above. For example, a portion of the above-described embodiment can also be replaced with another modification, and another modification can also be added to the above-described embodiment. When the technical feature is not described as essential, it can be deleted as appropriate.

What is claimed is:

1. A method of manufacturing an electricity storage device comprising:
an electrode body including a positive electrode having a long sheet shape and a negative electrode having a long sheet shape, the positive and negative electrodes being wound in a sheet longitudinal direction with a separator interposed therebetween, the electrode body having a pair of opposed wide surfaces;
a case having a cuboidal shape and configured to accommodate the electrode body, the case including a body having a first wall having a wide rectangular shape and an opening opposed to the first wall, and a sealing plate having a wide rectangular shape, opposed to the first wall and configured to seal the opening; and
an electrolyte solution,
the method comprising the steps of:
accommodating the electrode body in the body of the case so as to make the wide surfaces and the first wall opposed to each other;
injecting the electrolyte solution into the body after the accommodating step; and
sealing the opening of the body with the sealing plate after the injecting step.

2. The manufacturing method according to claim 1, wherein the injecting step is performed under negative pressure.

3. The manufacturing method according to claim 1, wherein the electrolyte solution is injected into the body through the opening in the injecting step.

4. The manufacturing method according to claim 1, wherein in the sealing step, the opening of the body is sealed while the wide surface of the electrode body is pressed with the sealing plate.

5. The manufacturing method according to claim 4, wherein a sealing plate provided with a convex portion is used as the sealing plate in the sealing step.

6. The manufacturing method according to claim 4, wherein a pressing force of at least 6 kN is applied to the wide surface of the electrode body in the sealing step.

7. An electricity storage device comprising:
an electrode body including a positive electrode having a long sheet shape and a negative electrode having a long sheet shape, the positive and negative electrodes being wound in a sheet longitudinal direction with a separator interposed therebetween, the electrode body having a pair of opposed wide surfaces;
a case having a cuboidal shape and configured to accommodate the electrode body, the case including a body having a first wall having a wide rectangular shape and an opening opposed to the first wall, and a sealing plate having a wide rectangular shape, opposed to the first wall, and configured to seal the opening; and
an electrolyte solution,
wherein
no injection hole for injecting the electrolyte solution into the case is provided.

8. The electricity storage device according to claim 7, wherein the sealing plate is provided with a convex portion protruding toward the wide surface of the electrode body.

9. The electricity storage device according to claim 8, wherein a rib portion protruding toward the wide surface is further provided in the convex portion.
